(19) United States
(12) Patent Application Publication
(10) Pub. No.: US 2015/0185851 A1
(43) Pub. Date: Jul. 2, 2015

(54) Device Interaction with Self-Referential Gestures

(71) Applicant: Google Inc., Mountain View, CA (US)

(72) Inventors: Alejandro Jose Kauffmann, San Francisco, CA (US); Christian Plagemann, Palo Alto, CA (US); Boris Smus, San Francisco, CA (US)

(73) Assignee: Google Inc., Mountain View, CA (US)

(21) Appl. No.: 14/143,001

(22) Filed: Dec. 30, 2013

(51) Int. Cl. G06F 3/01

(52) U.S. Cl. CPC G06F 3/017; G06F 3/011

(57) ABSTRACT

Described is a system and technique allowing a user to interact with a device using self-referential gestures. Self-referential gestures allow a user to rely on their inherent knowledge of body positioning to allow movements such as hand movements to be intuitively performed. The disclosure describes determining various reference points on the user and detecting hand movements relative to these reference points. In addition, a device may define axes and/or an origin in a three-dimensional space relative to a position of the user within a field-of-view of a capture device. Accordingly, gesture movements may be detected and/or measured based on references that correspond to the user's body in order to provide a more intuitive interaction experience.

### BACKGROUND

Touchless or in-air gestural interfaces often rely on mouse and touch-based input conventions, and thus treat a user's hand as an input pointer. Accordingly, these in-air gesture interfaces often adopt visual metaphors developed for pointer-based systems. The physical analogues of these metaphors, however, are often ill-suited for three-dimensional gesture interfaces. For example, when using in-air gestures in conjunction with a display screen, a dimensional disparity often exists between the unhindered three-dimensional movement in space of the user's hand and the two-dimensional output of a display screen. Accordingly, users are not typically adept at mentally projecting three-dimensional movements onto a two-dimensional display. Moreover, when providing a gesture, it may be necessary for a user to simultaneously divide their attention between performing the gesture and monitoring the visual feedback provided on the display. Accordingly, three-dimensional movements may not necessarily be intuitive for a user.

### BRIEF SUMMARY

Described is a system and technique allowing a user to interact with a device using self-referential gestures. In an implementation, described is a method including detecting, by a computing device, a user within a field-of-view of a capture device operatively coupled to the computing device, and identifying first and second reference points on the detected user, the first reference point providing an indication of a position of a first hand of the user. The method may also include detecting a gesture based on a movement of the first reference point relative to the second reference point, and performing, by the computing device and in response to the movement, a first action.

In an implementation, described is a method including detecting, by a computing device, a user within a field-of-view of a capture device operatively coupled to the computing device, and identifying first and second reference points, the first reference point providing an indication of a position of a first hand of the user. The method may also include determining, by the computing device, one or more axes in a three-dimensional space relative to a position of the user, the three-dimensional space including an origin corresponding to the second reference point, detecting a gesture based on a movement of the first reference point relative to the second reference point, and performing, by the computing device and in response to the movement, a first action.

In an implementation, described is a system including a processor configured to detect a user within a field-of-view of a capture device operatively coupled to the computing device, and identify first and second reference points on the detected user, the first reference point providing an indication of a position of a first hand of the user. The processor may also be configured to detect a gesture based on a movement of the first reference point relative to the second reference point, and perform, in response to the movement, a first action.

### BRIEF DESCRIPTION OF THE DRAWINGS

The accompanying drawings, which are included to provide a further understanding of the disclosed subject matter, are incorporated in and constitute a part of this specification. The drawings also illustrate implementations of the disclosed subject matter and together with the detailed description serve to explain the principles of implementations of the disclosed subject matter. No attempt is made to show structural details in more detail than may be necessary for a fundamental understanding of the disclosed subject matter and various ways in which it may be practiced.

FIG. 1 shows a functional block diagram of a representative device according to an implementation of the disclosed subject matter.

FIG. 2 shows an example network arrangement according to an implementation of the disclosed subject matter.

FIG. 3 shows an example arrangement of a device recognizing gestures according to an implementation of the disclosed subject matter.

FIG. 4 shows an example arrangement of a device recognizing gestures and orientating axes based on a position of a user according to an implementation of the disclosed subject matter.

FIG. 5 shows a flow diagram of a computing device recognizing gestures according to an implementation of the disclosed subject matter.

FIG. 6 shows an example of a gesture movement touching a joint of the user according to an implementation of the disclosed subject matter.

FIG. 7 shows an example of a gesture movement including altering the distance between hands of the user according to an implementation of the disclosed subject matter.

FIG. 8 shows an example of a hand rotation gesture according to an implementation of the disclosed subject matter.

FIG. 9 shows an example of a gesture movement altering the distance between hands along a Z-axis according to an implementation of the disclosed subject matter.

FIG. 10 shows an example of a threshold point according to an implementation of the disclosed subject matter.

### DETAILED DESCRIPTION

Described is a system and technique allowing a user to interact with a device using self-referential gestures. Self-referential gestures allow a user to rely on their inherent knowledge of body positioning to allow movements such as hand movements to be intuitively performed. The disclosure describes determining various reference points on the user and detecting hand movements relative to these reference points. In addition, a device may define axes and/or an origin in a three-dimensional space relative to a position of the user within a field-of-view of a capture device. Accordingly, gesture movements may be detected and/or measured based on references that correspond to the user's body in order to provide a more intuitive interaction experience.

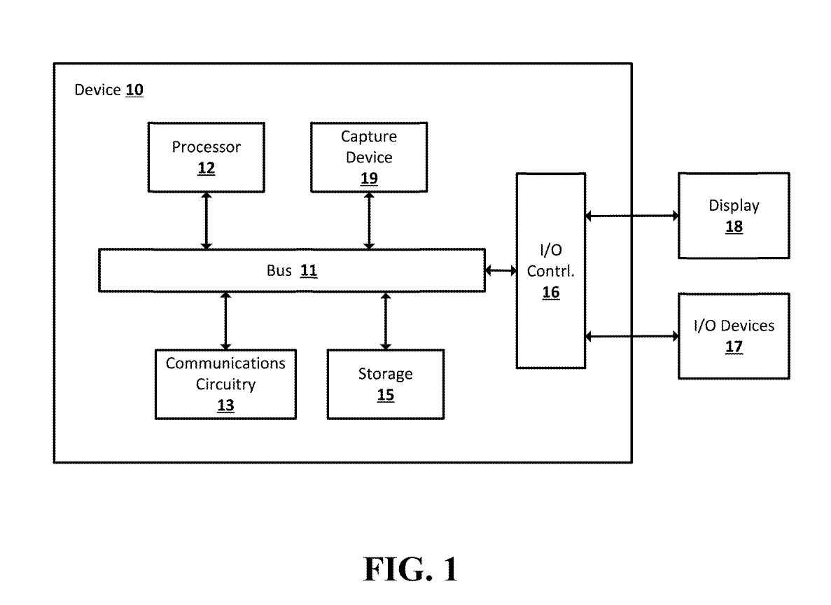

FIG. 1 shows a functional block diagram of a representative device according to an implementation of the disclosed subject matter. The device 10 may include a bus 11, processor 12, memory 14, I/O controller 16, communications circuitry 13, storage 15, and a capture device 19. The device 10 may also include or may be coupled to a display 18 and one or more I/O devices 17.

The device 10 (or computing device) may include or be part of a variety of types of devices, such as a set-top box, television, media player, mobile phone (including a “smartphone”), computer, or other type of device. The processor 12 may be any suitable programmable control device and may control the operation of one or more processes, such as gesture recognition as discussed herein, as well as other processes performed by the device 10. As described herein, actions may be performed by a computing device, which may refer to a device (e.g. device 10) and/or one or more processors (e.g. processor 12). The bus 11 may provide a data transfer path for transferring between components of the device 10.

The memory 14 may include one or more different types of memory which may be accessed by the processor 12 to perform device functions. For example, the memory 14 may include any suitable non-volatile memory such as read-only memory (ROM), electrically erasable programmable read only memory (EEPROM), flash memory, and the like, and any suitable volatile memory including various types of random access memory (RAM) and the like.

The communications circuitry 13 may include circuitry for wired or wireless communications for short-range and/or long range communication. For example, the wireless communication circuitry may include Wi-Fi enabling circuitry for one of the 802.11 standards, and circuitry for other wireless network protocols including Bluetooth, the Global System for Mobile Communications (GSM), and code division multiple access (CDMA) based wireless protocols. Communications circuitry 13 may also include circuitry that enables the device 10 to be electrically coupled to another device (e.g. a computer or an accessory device) and communicate with that other device. For example, a user input component such as a wearable device may communicate with the device 10 through the communication circuitry 13 using a short-range communication technique such as infrared (IR) or other suitable technique.

The storage 15 may store software (e.g., for implementing various functions on device 10), and any other suitable data. The storage 15 may include a storage medium including various forms volatile and non-volatile memory. Typically, the storage 15 includes a form of non-volatile memory such as a hard-drive, solid state drive, flash drive, and the like. The storage 15 may be integral with the device 10 or may be separate and accessed through an interface to receive a memory card, USB drive, optical disk, a magnetic storage medium, and the like.

An I/O controller 16 may allow connectivity to a display 18 and one or more I/O devices 17. The I/O controller 16 may include hardware and/or software for managing and processing various types of I/O devices 17. The I/O devices 17 may include various types of devices allowing a user to interact with the device 10. For example, the I/O devices 17 may include various input components such as a keyboard/keypad, controller (e.g. game controller, remote, etc.) including a smartphone that may act as a controller, a microphone, and other suitable components. The I/O devices 17 may also include components for aiding in the detection of gestures including wearable components such as a watch, ring, or other components that may be used to track body movements (e.g. holding a smartphone to detect movements).

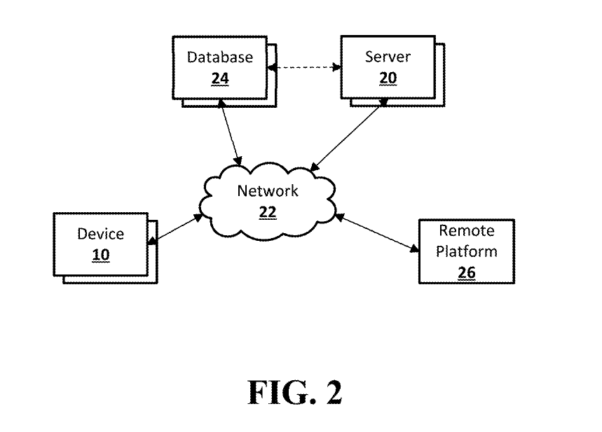

The device 10 may or may not be coupled to a display. In implementations where the device 10 is coupled to a display (as shown in FIGS. 1 and 2), the device 10 may be integrated with or be part of a display 18 (e.g. integrated into a television unit). The display 18 may be any a suitable component for displaying visual output such as a television, computer screen, projector, and the like. The display 18 may include an interface that allows a user to interact with the display 18 or additional components coupled to the device 10. The interface may include menus, overlays, and other display elements that are displayed on a display screen to provide visual feedback to the user.

The device 10 may include a capture device 19 (as shown in FIGS. 1 and 2). Alternatively, the device 10 may be coupled to the capture device 19 through the I/O controller 16 in a similar manner as described with respect to a display 18. For example, a computing device (e.g. server and/or a remote processor) may receive data from a capture device 19 (e.g. webcam or similar component) that is local to the user. The capture device 19 enables the device 10 to capture still images, video, or both. The capture device 19 may include one or more cameras for capturing an image or series of images continuously, periodically, at select times, and/or under select conditions. The capture device 19 may be used to visually monitor one or more users such that gestures and/or movements performed by the one or more users may be captured, analyzed, and tracked to detect a gesture input as described further herein.

The capture device 19 may be configured to capture depth information including a depth image using techniques such as time-of-flight, structured light, stereo image, or other suitable techniques. The depth image may include a two-dimensional pixel area of the captured image where each pixel in the two-dimensional area may represent a depth value such as a distance. The capture device 19 may include two or more physically separated cameras that may view a scene from different angles to obtain visual stereo data to generate depth information. Other techniques of depth imaging may also be used. The capture device 19 may also include additional components for capturing depth information of an environment such as an IR light component, a three-dimensional camera, and a visual image camera (e.g. RGB camera). For example, with time-of-flight analysis the IR light component may emit an infrared light onto the scene and may then use sensors to detect the backscattered light from the surface of one or more targets (e.g. users) in the scene using a three-dimensional camera or RGB camera. In some instances, pulsed infrared light may be used such that the time between an outgoing light pulse and a corresponding incoming light pulse may be measured and used to determine a physical distance from the capture device 19 to a particular location on a target.

FIG. 2 shows an example network arrangement according to an implementation of the disclosed subject matter. A device 10 may communicate with other devices 10, a server 20, and a database 24 via the network 22. The network 22 may be a local network, wide-area network (including the Internet), and other suitable communications network. The network 22 may be implemented on any suitable platform including wired and wireless technologies. Server 20 may be directly accessible a device 10, or one or more other devices 10 may provide intermediary access to a server 20. The device 10 and server 20 may access a remote platform 26 such as cloud computing arrangement or service. The remote platform 26 may include one or more servers 20 and databases 24. The term server may be used herein and may include a single server or one or more servers.

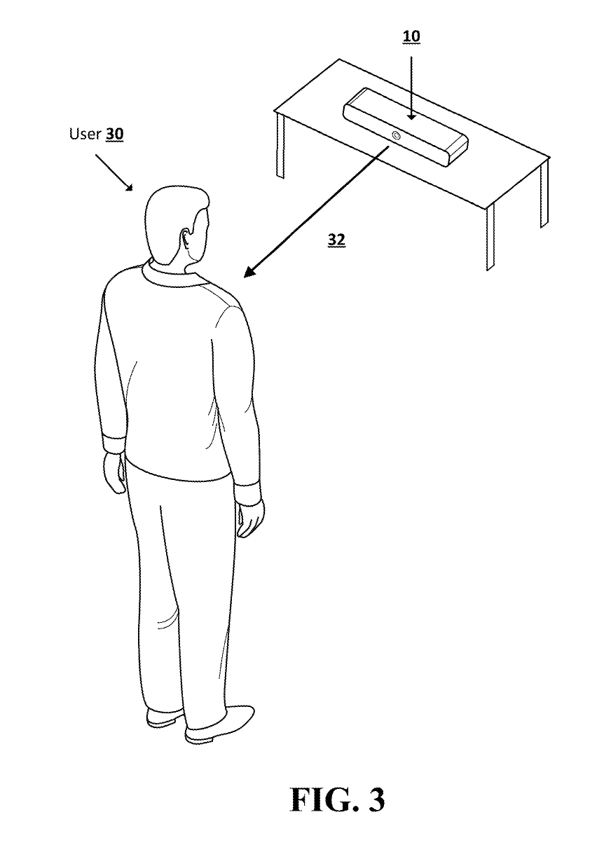

FIG. 3 shows an example arrangement of a device recognizing gestures according to an implementation of the disclosed subject matter. A user 30 may interact with the device 10 by performing various gestures as described further herein. The device 10 may detect gesture movements from a user 30 based on measuring and/or recognizing various body movements of the user 30. The criteria for detecting a gesture may vary between applications and between contexts of a single application including variance over time. Gestures may include in-air type gestures that may be performed within a three-dimensional environment. In addition, these in-air gestures may include touchless gestures that do not require inputs to a touch surface. Typically, the movements include hand movements and/or finger movements, but other forms of movement may also be recognized. For example, the device 10 may detect movements of a user's arms, legs, feet, and other movements such as changes in body positions or other types of identifiable movements from a user. These identifiable movements may also include head movements including nodding, shaking, and other movements, as well as facial movements such as eye tracking, and/or blinking. In addition, gestures may be based on combinations of movements described above including being coupled with speech commands and/or other parameters. For example, a gesture may be identified based on a hand movement in combination with tracking the movement of the user's eyes, or a hand movement in coordination with a speech command.

When detecting gesture movements, specific gestures may be detected based on information defining a gesture, condition, and/or other information. For example, gestures may be recognized based on information such as a distance of movement (either absolute or relative to the size of the user), a threshold velocity of the movement, a confidence rating, and other criteria. The device may identify one or more reference points on the user in order to track gesture movements. For example, the capture device may employ depth-based full-body tracker that identifies skeletal joints. A joint may include points at which bones connect, and accordingly, allow for movement. For example, a joint may include joints associated with a hand, wrist, elbow, shoulders and/or chest, face (e.g. jaw), hips, knees, ankles, and feet among others. In another example, the device may select a finger or a palm of an open hand as a reference point when tracking hand movements. When detecting gesture movements, the device may track movements using a coordinate system for a three-dimensional space. The device may define a coordinate space relative to an orientation of the capture device, relative to a position of the user, and/or other technique. In order define and/or translate a coordinate system based on a position of a user, the device may utilize a reference point as an origin of the coordinate system. This point of origin may relate to a natural point of reference for a user when performing self-referential gestures. For example, the device may select a point on a central part of the body (e.g. torso) of a user as a reference point when tracking body movements such as the center of a chest, sternum, solar plexus, center of gravity, or within regions such as the thorax, abdomen, pelvis, and the like. The device may also use the head as a reference point for an origin. In another example, the device may use a hand and/or an initial movement of a hand to establish a point of origin for a coordinate system. Accordingly, the device may detect and/or measure subsequent hand movements relative to the established point on the hand. For example, a user may perform an open palm gesture, and in response, the device may establish a point of origin within the palm of the hand. Accordingly, a Y-axis may be defined as substantially along the established point on the palm to a point (e.g. fingertip) of the corresponding index or middle finger (the X-axis and Z-axis may then be defined based on the defined Y-axis).

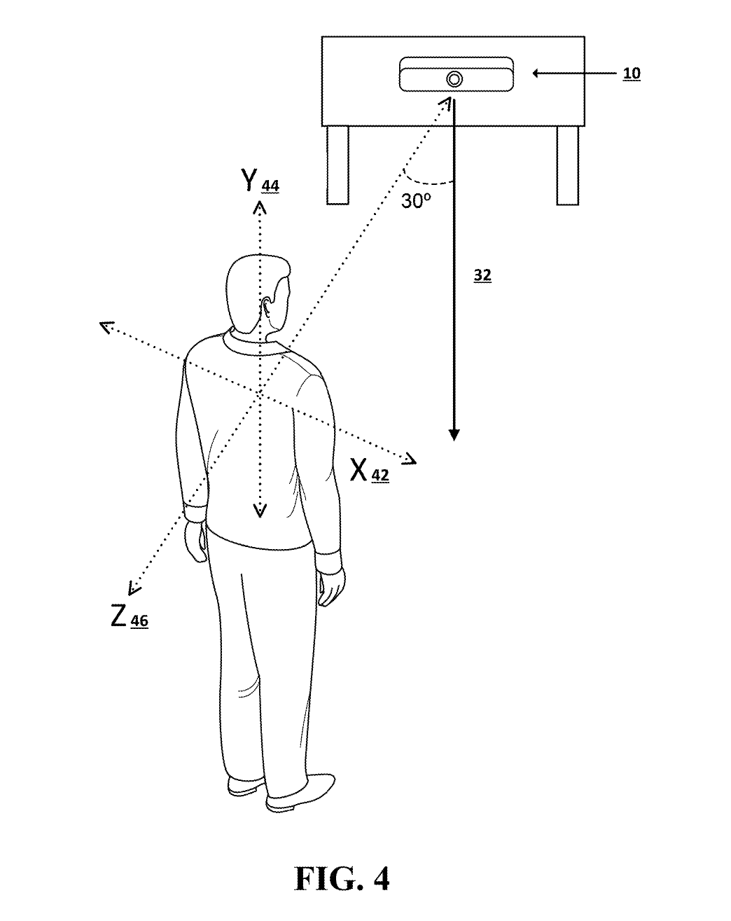

As described, gestures may include movements within a three-dimensional environment, and accordingly, the gestures may include components of movement along one or more axes. As shown in the example of FIG. 3, the user 30 may be aligned with a direct line 32 from the capture device. In addition to defining axes in relation to the capture device, the axes may be established using various techniques. Axes may be established relative to the capture device, relative to the user's torso (e.g. as shown in FIG. 4), relative to the user's face, relative to the alignment of two users, and/or other techniques. Axes may also be established relative to the direction of a first detected movement. For example, a first detected movement may include a substantially up/down hand gesture and a positioning of a Y-axis may be defined based on this movement.

FIG. 4 shows an example arrangement of a device recognizing gestures and orientating axes based on a position of a user according to an implementation of the disclosed subject matter. As shown, the user 30 may be positioned at an offset (30 degrees in this example) from the direct line 32 from the capture device. Accordingly, the device may define axes based on the position of the user. These axes may be described as including an X-axis 42, Y-axis 44, and Z-axis 46. The X-axis 42 may be defined as substantially parallel to a line connecting a left and a right shoulder of the user 30. For example, left or right type movements such as a swiping motion may be along the X-axis 42. The Y-axis 44 may be defined as substantially parallel to a line connecting a head and a pelvis of the user 30. For example, up and down type movements such as a raise or lower/drop motion may be along the Y-axis 44. The Z-axis may be defined as substantially perpendicular to the X-axis and Y-axis. For example, forward and back type movements such as a push or pull motion may be along the Z-axis 46. Movements may be detected along a combination of these axes, or components of a movement may be determined along a single axis depending on a particular context. As described herein, an axis may be described with reference to a user's body. It should be noted that these references may be used in relation to a claim, but are illustrative of the axes and not necessarily how a device may actually define and/or determine an axis. For example, an axis may be described as being defined by a line connecting a left shoulder and right shoulder, but the device may use other techniques such as multiple points including points on the head, pelvis, etc. Accordingly, the computing device may use different reference points to define substantially equivalent axes as described herein for gesture movements in order to distinguish between, for example, left/right, forward/back, and up/down movements as perceived by the user.

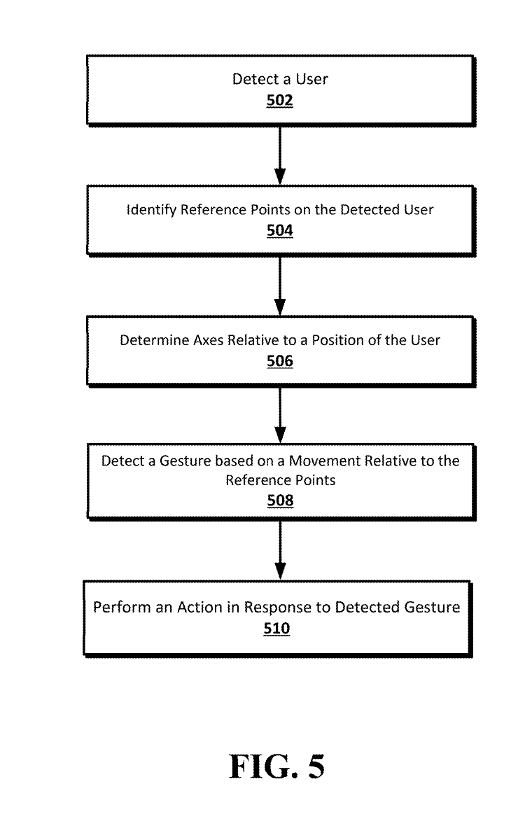

FIG. 5 shows a flow diagram of a computing device recognizing gestures according to an implementation of the disclosed subject matter. In 502, the computing device (or “device”) may detect a user within a field-of-view of a capture device (e.g. capture device 19) operatively coupled to the device. Detecting may include the device performing the actual detection and/or the device receiving and indication that one or more users have been detected by the capture device. For example, a computing device (e.g. server 20) may receive an indication from a remotely located capture device (e.g. capture device 19 that may be part of device 10) that a user has been detected. The device may detect a user based on detecting particular shapes (e.g. face) that may correspond to a user, motion (e.g. via a motion detector that may be part of or separate from the capture device), sound (e.g. a speech command), and/or other forms of stimuli. The device may detect the entire body of a user or portions of the user. In response to the detection of one or more users, the device may activate the capture device (if not already activated). For example, the device may detect the presence of a user based on a speech input, and in response, the device may activate the capture device. Upon detecting a user, the device may initiate gesture detection. As described above, gesture detection may track a position of a user and/or particular features (e.g. hands, face, etc.). The device may also determine the number of users within a field-of-view.

A field-of-view as described herein may include an area perceptible by one or more capture devices (e.g. perceptible visual area). In an implementation, the device may determine one or more identities (e.g. via a recognition technique) in response to detecting the presence of the one or more users. For example, the device may attempt to identify a user within the field-of-view in order to perform context and/or user specific actions. For example, the device may perform facial recognition for disambiguation. For instance, the device may disambiguate a gesture such as a pointing gesture to determine the identity of the user that is being referenced. In another example, the device may disambiguate words of a speech commands that may supplement a gesture. For example, these speech commands may include words such as personal pronouns (e.g. “open may calendar,” “send him this picture,” etc.).

In 504, the device may identify first and second reference points on the detected user. The device may track particular features of the user, for example, using skeletal tracking to identify particular points of interest. For example, the reference point may correspond to a joint on the user as well as other points on the body such as on the user's head, torso, etc. In an implementation, the first reference point may provide an indication of a position of a first hand of the user. For example, the point may include a point on the palm and/or finger of the user. As described further herein, a reference point may also include a point within the three-dimensional space.

In 506, the device may determine one or more axes in a three-dimensional space relative to a position of the user. As described above, the axes may be determined based on reference points on the user. When determining movements, the device may define a three-dimensional space that includes an origin for a coordinate system. For example, the origin may correspond to a reference point that may or may not be used to define one or more axes. In one example, the origin may correspond to a reference point on a torso of the user. In another example, the origin may correspond to a reference point on the first hand of the user. In addition, the device may establish a point of origin based on an initial gesture. For example, the device may establish an origin within a palm of the first hand as a result of the user performing a gesture by the first hand with a substantially open palm. Accordingly, the device may determine subsequent gesture movements relative to the initial gesture.

In 508, the device may detect a gesture based on a movement of the first reference point relative to the second reference point. Techniques described herein may determine movements based on reference points of the user's body rather than points relative to the capture device. The movement of the first reference point relative to the second reference point may include a change in distance, a rotation, a change in position, and other types of movements that may correspond to a gesture. For example, the movement may include a hand touching the second reference point.

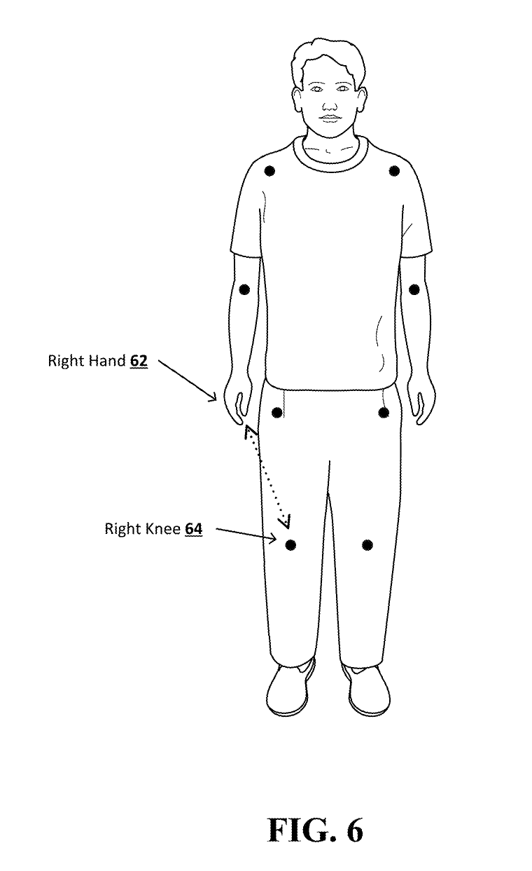

FIG. 6 shows an example of a gesture movement touching a joint of the user according to an implementation of the disclosed subject matter. As shown, the gesture movement may include a right hand 62 touching a right knee 64. The user may also touch one or more other joints (e.g. as shown in FIG. 6) to perform a gesture movement. In addition, the reference points may correspond to each hand of the user.

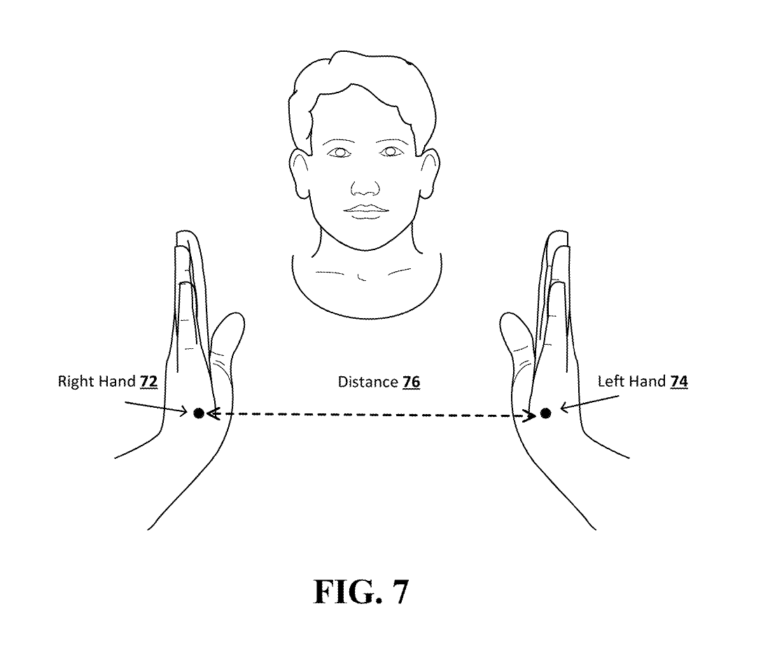

FIG. 7 shows an example of a gesture movement including altering the distance between hands of the user according to an implementation of the disclosed subject matter. As shown, the first and second reference points may correspond to a point on right hand 72 and left hand 74 of the user. As shown, the device may detect and/or measure distance 76 between hands along the X-axis of a gesture movement. For example, this type of movement may be used when performing an action and/or command including a dynamic input such as a volume control or playback speed. In addition, as described further herein, the distance between the hands may be measured relative to the user and not the capture device. For example, the user may be positioned at on offset (e.g. as shown in FIG. 4), but the device may determine and/or translate the distance between the hands as perceived by the user and not the distance that may be perceived by the capture device. As described, other types of movements may also be performed.

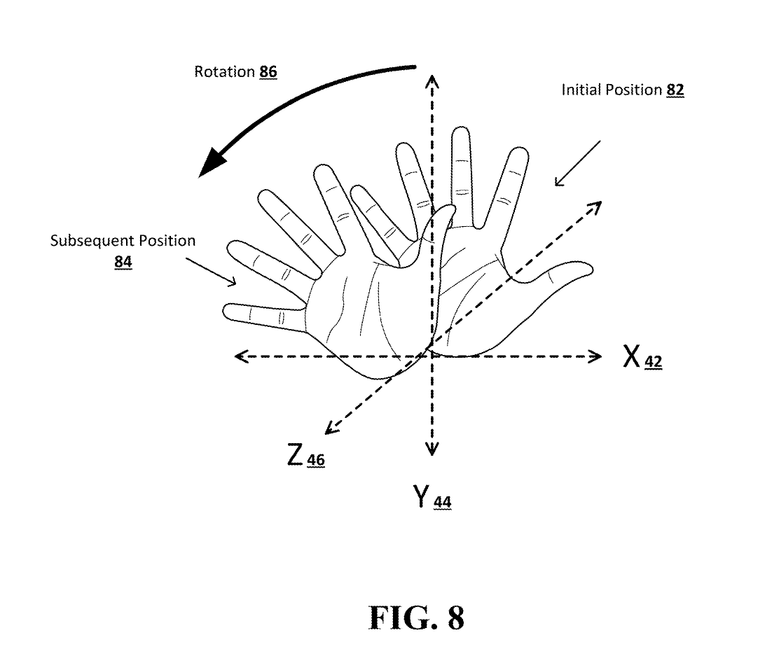

FIG. 8 shows an example of a hand rotation gesture according to an implementation of the disclosed subject matter. In an implementation, the movement may include a rotation movement. For example, as shown the hand (right hand in this example) movement may include a rotation 86 from an initial position 82 to a subsequent position 84. In this example, the axis of rotation is substantially along the Z-axis 46. As described above, reference points may correspond to points in the hand. For example, in order to detect a rotation, a first reference point may correspond to a point on a finger (e.g. index or middle) and the second reference point may correspond to a point on the hand the remains substantially still during a rotation (e.g. a point on the palm). Accordingly, the device may measure the degree that the hand rotates and perform a corresponding action. For example, the rotation may adjust volume (e.g. mimic turning a volume knob) or other dynamic action. In another example, a rotation to the right may perform a forward or next action (e.g. forward on a browser, fast forward, next track, etc.) and a rotation to the left may perform a back or previous action (e.g. back on a browser, rewind, previous track, etc.). The device may also detect and/or measure gesture movements relative to the position of the user.

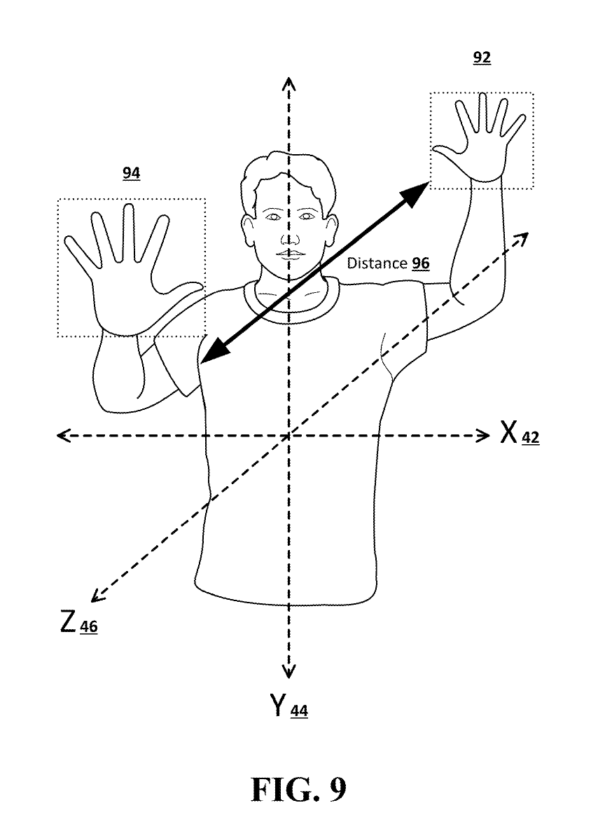

FIG. 9 shows an example of a gesture movement altering the distance between hands along a Z-axis according to an implementation of the disclosed subject matter. The device may determine a distance between hands along different axes. For example, as shown in the previous example in FIG. 7, the distance may be measured substantially along the X-axis. As shown in the example of FIG. 9, the device may also detect and/or measure distance between hands of a gesture movement along the Z-axis 46. When determining a distance between hands, the device may compare a scale of the first hand to the second hand. For example, the hand that is further back 92 along the Z-axis may appear smaller than the hand that is closer 94 to the capture device. Accordingly, the device may determine a distance between the hands by factoring a scale and/or size of the hands as perceived by the capture device. The device may also use additional reference points within the three-dimensional space that may not be on the user.

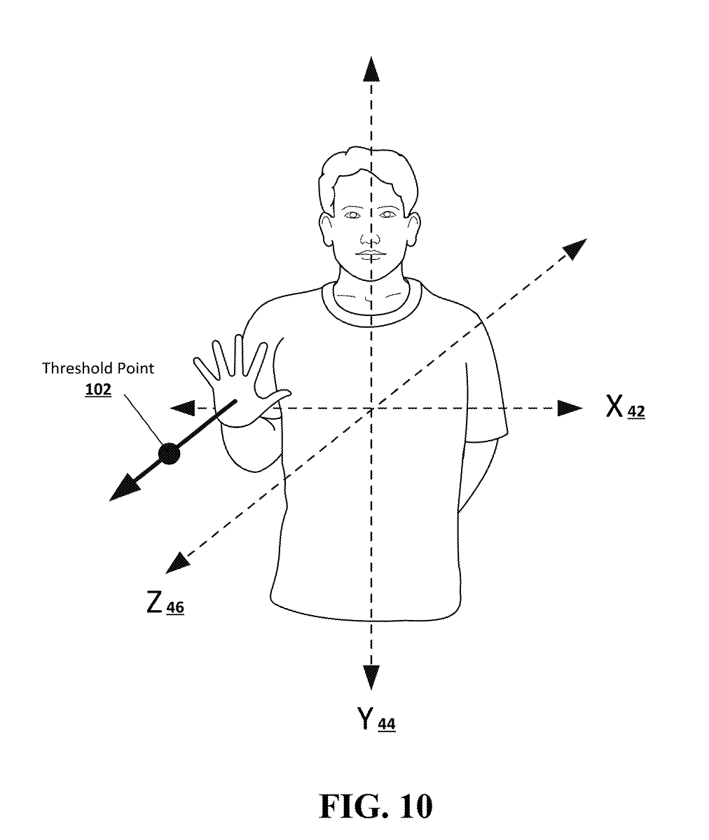

FIG. 10 shows an example of a threshold point according to an implementation of the disclosed subject matter. The device may establish a reference point that corresponds to a point within the three-dimensional space that is away from the user. Accordingly, the device may use this threshold point 102 as a reference for particular gesture movements. For example, the device may detect gesture movements that include a movement beyond the threshold point. For instance, the device may detect a push-hand gesture along a Z-axis that moves beyond the threshold point that has a component along the Z-axis.

Returning to FIG. 5, in 510 the device may perform an action in response to the detected gesture. For example, the device may perform (e.g. execute) various actions that may control the device. The device may also measure the detected gesture movements, and accordingly, actions may be based on the measured movements. For example, actions may include, but are not limited to, to control of the device (e.g. turn on or off, louder, softer, increase, decrease, mute, output, clear, erase, brighten, darken, etc.), communications (e.g. e-mail, mail, call, contact, send, receive, get, post, tweet, text, etc.), document processing (e.g. open, load, close, edit, save, undo, replace, delete, insert, format, etc.), searches (e.g., find, search, look for, locate, etc.), content delivery (e.g. show, play, display), and/or other actions and/or commands.

Various implementations may include or be embodied in the form of computer-implemented process and an apparatus for practicing that process. Implementations may also be embodied in the form of a computer-readable storage containing instructions embodied in a non-transitory and tangible storage and/or memory, wherein, when the instructions are loaded into and executed by a computer (or processor), the computer becomes an apparatus for practicing implementations of the disclosed subject matter.

The flow diagrams described herein are included as examples. There may be variations to these diagrams or the steps (or operations) described therein without departing from the implementations described herein. For instance, the steps may be performed in parallel, simultaneously, a differing order, or steps may be added, deleted, or modified. Similarly, the block diagrams described herein are included as examples. These configurations are not exhaustive of all the components and there may be variations to these diagrams. Other arrangements and components may be used without departing from the implementations described herein. For instance, components may be added, omitted, and may interact in various ways known to an ordinary person skilled in the art.

References to “one implementation,” “an implementation,” “an example implementation,” and the like, indicate that the implementation described may include a particular feature, but every implementation may not necessarily include the feature. Moreover, such phrases are not necessarily referring to the same implementation. Further, when a particular feature is described in connection with an implementation, such feature may be included in other implementations whether or not explicitly described. The term “substantially” may be used herein in association with a claim recitation and may be interpreted as “as nearly as practicable,” “within technical limitations,” and the like. Terms such as first, second, etc. may be used herein to describe various elements, and these elements should not be limited by these terms. These terms may be used distinguish one element from another. For example, a first reference point may be termed a second reference point, and, similarly, a second reference point may be termed a first reference point.

The foregoing description, for purpose of explanation, has been described with reference to specific implementations. However, the illustrative discussions above are not intended to be exhaustive or to limit implementations of the disclosed subject matter to the precise forms disclosed. The implementations were chosen and described in order to explain the principles of implementations of the disclosed subject matter and their practical applications, to thereby enable others skilled in the art to utilize those implementations as well as various implementations with various modifications as may be suited to the particular use contemplated.

1-42. (canceled)

43. A computer-implemented method comprising:
obtaining multiple images that are taken by a camera;
determining that the images show a user performing a gesture that involves the user holding their hands in a first position, in which one hand is held a first distance from the camera and the other hand is held a second distance from the camera, then moving their hands to a second position, in which the one hand is held a third distance from the camera and the other hand is held a fourth distance from the camera;
determining a first value that reflects the first difference between the first distance and the second distance, and a second value that reflects the second difference between the third distance and the fourth distance; and
adjusting a parameter of an application that is executing on a computer based at least on the first value and the second value.

44. The computer-implemented method of claim 43, comprising:
identifying a physical feature of the user as a reference point;
determining, based at least on the reference point, a first scaling factor and a second scaling factor;
scaling the first value by the first scaling factor to generate a scaled first value;
scaling the second value by the second scaling factor to generate a scaled second value;
wherein adjusting the parameter of the application that is executing on the computer is further based on the scaled first value and the scaled second value.

45. The computer-implemented method of claim 43, wherein determining the first value that reflects the first difference between the first distance and the second distance, and the second value that reflects the second difference between the third distance and the fourth distance, comprises:
comparing an image size of the one hand in the first position to an image size of the other hand in the first position and the second distance,
comparing an image size of the one hand in the second position to an image size of the other hand in the second position, and
based at least on (i) comparing the image size of the one hand in the first position to the image size of the other hand in the first position and the second distance, and (ii) comparing the image size of the one hand in the second position to the image size of the other hand in the second position, determining the first value that reflects the first difference between the first distance and the second distance, and the second value that reflects the second difference between the third distance and the fourth distance.

46. The computer-implemented method of claim 43, comprising:
determining that the user's body is offset from a plane that is perpendicular to a line-of-sight of the camera by a first angle; and
wherein adjusting the parameter of the application that is executing on the computer is further based on the first angle.

47. The computer-implemented method of claim 43, comprising:
identifying a physical feature in a space around the user as a reference point;
determining, based at least on the reference point, a first scaling factor and a second scaling factor;
scaling the first value by the first scaling factor to generate a scaled first value;
scaling the second value by the second scaling factor to generate a scaled second value;
wherein adjusting the parameter of the application that is executing on the computer is further based on the scaled first value and the scaled second value.

48. The computer-implemented method of claim 43, wherein the first difference between the first distance and the second distance corresponds to a first difference between the first distance and the second distance along a first axis in three-dimensional space, and
wherein the second difference between the third distance and the fourth distance corresponds to a second difference between the third distance and the fourth distance along the first axis in three-dimensional space;
wherein the method further comprises determining, based at least on the first value, a fourth value that reflects a distance between the one hand and the other hand along a second axis in three-dimensional space, and based at least on the second value, a fifth value that reflects a distance between the one hand and the other hand along the second axis in three-dimensional space, and
wherein adjusting the parameter of the application that is executing on the computer is further based on the third value and the fourth value.

49. The computer-implemented method of claim 43, comprising:
determining a velocity associated with one or more of the one hand and the other hand in moving from the first position to the second position,
wherein the parameter of the application that is executing on the computer is further adjusted based on the velocity associated with one or more of the one hand and the other hand in moving from the first position to the second position.

50. A non-transitory computer-readable storage device having instructions stored thereon that, when executed by a computing device, cause the computing device to perform operations comprising:
obtaining multiple images that are taken by a camera;
determining that the images show a user performing a gesture that involves the user holding their hands in a first position, in which one hand is held a first distance from the camera and the other hand is held a second distance from the camera, then moving their hands to a second position, in which the one hand is held a third distance from the camera and the other hand is held a fourth distance from the camera;
determining a first value that reflects the first difference between the first distance and the second distance, and a second value that reflects the second difference between the third distance and the fourth distance; and
adjusting a parameter of an application that is executing on a computer based at least on the first value and the second value.

51. The storage device of claim 50, wherein the operations further comprise:
identifying a physical feature of the user as a reference point;
determining, based at least on the reference point, a first scaling factor and a second scaling factor;
scaling the first value by the first scaling factor to generate a scaled first value;
scaling the second value by the second scaling factor to generate a scaled second value;
wherein adjusting the parameter of the application that is executing on the computer is further based on the scaled first value and the scaled second value.

52. The storage device of claim 50, wherein determining the first value that reflects the first difference between the first distance and the second distance, and the second value that reflects the second difference between the third distance and the fourth distance, comprises:
comparing an image size of the one hand in the first position to an image size of the other hand in the first position and the second distance,
comparing an image size of the one hand in the second position to an image size of the other hand in the second position, and
based at least on (i) comparing the image size of the one hand in the first position to the image size of the other hand in the first position and the second distance, and (ii) comparing the image size of the one hand in the second position to the image size of the other hand in the second position, determining the first value that reflects the first difference between the first distance and the second distance, and the second value that reflects the second difference between the third distance and the fourth distance.

53. The storage device of claim 50, wherein the operations further comprise:
determining that the user's body is offset from a plane that is perpendicular to a line-of-sight of the camera by a first angle; and
wherein adjusting the parameter of the application that is executing on the computer is further based on the first angle.

54. The storage device of claim 50, wherein the operations further comprise:
identifying a physical feature in a space around the user as a reference point;
determining, based at least on the reference point, a first scaling factor and a second scaling factor;
scaling the first value by the first scaling factor to generate a scaled first value;
scaling the second value by the second scaling factor to generate a scaled second value;
wherein adjusting the parameter of the application that is executing on the computer is further based on the scaled first value and the scaled second value.

55. The storage device of claim 50, wherein the first difference between the first distance and the second distance corresponds to a first difference between the first distance and the second distance along a first axis in three-dimensional space, and
wherein the second difference between the third distance and the fourth distance corresponds to a second difference between the third distance and the fourth distance along the first axis in three-dimensional space;
wherein the method further comprises determining, based at least on the first value, a fourth value that reflects a distance between the one hand and the other hand along a second axis in three-dimensional space, and based at least on the second value, a fifth value that reflects a distance between the one hand and the other hand along the second axis in three-dimensional space, and
wherein adjusting the parameter of the application that is executing on the computer is further based on the third value and the fourth value.

56. The storage device of claim 50, wherein the operations further comprise:
determining a velocity associated with one or more of the one hand and the other hand in moving from the first position to the second position,
wherein the parameter of the application that is executing on the computer is further adjusted based on the velocity associated with one or more of the one hand and the other hand in moving from the first position to the second position.

57. A system comprising:
one or more data processing apparatus; and
a computer-readable storage device having stored thereon instructions that, when executed by the one or more data processing apparatus, cause the one or more data processing apparatus to perform operations comprising:
obtaining multiple images that are taken by a camera;
determining that the images show a user performing a gesture that involves the user holding their hands in a first position, in which one hand is held a first distance from the camera and the other hand is held a second distance from the camera, then moving their hands to a second position, in which the one hand is held a third distance from the camera and the other hand is held a fourth distance from the camera;
determining a first value that reflects the first difference between the first distance and the second distance, and a second value that reflects the second difference between the third distance and the fourth distance; and
adjusting a parameter of an application that is executing on a computer based at least on the first value and the second value.

58. The system of claim 57, wherein the operations further comprise:
identifying a physical feature of the user as a reference point;
determining, based at least on the reference point, a first scaling factor and a second scaling factor;
scaling the first value by the first scaling factor to generate a scaled first value;
scaling the second value by the second scaling factor to generate a scaled second value;
wherein adjusting the parameter of the application that is executing on the computer is further based on the scaled first value and the scaled second value.

59. The system of claim 57, wherein determining the first value that reflects the first difference between the first distance and the second distance, and the second value that reflects the second difference between the third distance and the fourth distance, comprises:
comparing an image size of the one hand in the first position to an image size of the other hand in the first position and the second distance,
comparing an image size of the one hand in the second position to an image size of the other hand in the second position, and
based at least on (i) comparing the image size of the one hand in the first position to the image size of the other hand in the first position and the second distance, and (ii) comparing the image size of the one hand in the second position to the image size of the other hand in the second position, determining the first value that reflects the first difference between the first distance and the second distance, and the second value that reflects the second difference between the third distance and the fourth distance.

60. The system of claim 57, wherein the operations further comprise:
determining that the user's body is offset from a plane that is perpendicular to a line-of-sight of the camera by a first angle; and
wherein adjusting the parameter of the application that is executing on the computer is further based on the first angle.

61. The system of claim 57, wherein the operations further comprise:
identifying a physical feature in a space around the user as a reference point;
determining, based at least on the reference point, a first scaling factor and a second scaling factor;
scaling the first value by the first scaling factor to generate a scaled first value;
scaling the second value by the second scaling factor to generate a scaled second value;
wherein adjusting the parameter of the application that is executing on the computer is further based on the scaled first value and the scaled second value.

62. The system of claim 57, wherein the first difference between the first distance and the second distance corresponds to a first difference between the first distance and the second distance along a first axis in three-dimensional space, and
wherein the second difference between the third distance and the fourth distance corresponds to a second difference between the third distance and the fourth distance along the first axis in three-dimensional space;
wherein the method further comprises determining, based at least on the first value, a fourth value that reflects a distance between the one hand and the other hand along a second axis in three-dimensional space, and based at least on the second value, a fifth value that reflects a distance between the one hand and the other hand along the second axis in three-dimensional space, and
wherein adjusting the parameter of the application that is executing on the computer is further based on the third value and the fourth value.
